(19) United States
(12) Patent Application Publication
(10) Pub. No.: US 2005/0074118 A1
(43) Pub. Date: Apr. 7, 2005

(54) Secure communication

(76) Inventors: Elizabeth Wilhite, Spokane Valley, WA (US); Albert Henry Carlson, Moscow, ID (US); Darin Mitchell Evans, Boise, ID (US); Justin Michael Cassidy, Anchorage, AK (US); Thomas Main DuBuisson, Baltimore, MD (US); Phillip Lee Gregg, Moscow, ID (US)

Correspondence Address: Ormiston & McKinney, 802 W. Bannock, Suite 400, P.O. Box 298, Boise, ID, 83701-0298, US

(21) Appl. No.: 10/846,713

(22) Filed: May 14, 2004

Related U.S. Application Data
(60) Provisional application No. 60/470,693, filed on May 15, 2003.

(51) Int. Cl. H04L 9/00

(52) U.S. Cl. 380/44

(57) ABSTRACT

A method for generating a key includes reading a network data stream, selecting portions of data from the data stream, and assembling the selected portions to form the key. The key can then be used to alter a network communication.

### CROSS REFERENCE TO RELATED APPLICATIONS

This application claims the priority of provisional application Ser. No. 60/470,693 filed May 15, 2003.

### BACKGROUND

Randomness and random numbers have traditionally been used for a variety of purposes such as games of chance. With the advent of computers, people recognized the need for a means of introducing randomness into a computer program and computer generated output. Surprising as it may seem, however, it is difficult to get a computer to do something by chance. A computer running a program follows its instructions blindly and is therefore completely predictable.

Software engineers ordinarily choose to introduce randomness into computer algorithms in the form of pseudo-random number generators. As the name suggests, pseudo-random numbers are not truly random. Rather, they are computed from mathematical formulae or simply taken from a pre-calculated list. A lot of research has gone into pseudo-random number theory and modern algorithms for generating them are so good that the numbers look as if they are purely random. Pseudo-random numbers, however, have the characteristic that they are deterministic, meaning they can be predicted if one knows where in the sequence the first number is taken or one analyzes a sufficiently long sequence of pseudo-random numbers. For some purposes, predictability is a good characteristic, for others it is not.

Random numbers are used for computer games as well as for more serious applications such as the generation of cryptographic keys and for some classes of scientific experiments. For scientific experiments, it is convenient that a series of random numbers can be replayed for use in several experiments, and pseudo-random numbers are well suited for this purpose. For cryptographic use, however, it is important that the numbers used to generate keys are not just seemingly random; they should be truly unpredictable.

Cryptographic algorithms come in a variety of flavors. Some are strong (meaning difficult to crack) but make substantial demands on processing power and key management. Others are weak (meaning easier to crack) but generally less demanding and therefore better suited for some applications. All strong cryptography requires true random numbers to generate keys, but the number of random numbers required depends on the encryption scheme. The strongest possible method, One Time Pad (OTP for short) encryption, is the most demanding of all; it requires as many random bits as there are bits of information to be encrypted.

True random numbers are typically generated by sampling and processing a source of entropy outside the computer. A source of entropy can be very simple, like the little variations in somebody's mouse movements or in the amount of time between keystrokes. In practice, however, it can be tricky to use user input as a source of entropy. Keystrokes, for example, are often buffered by the computer's operating system, meaning that several keystrokes are collected before they are sent to the program waiting for them. To the program, it will seem as though the keys were pressed almost simultaneously. Additionally, the behavior of a single user may be cyclical or predictable over a period of time. A good source of entropy is a radioactive source. The points in time at which a radioactive source decays are completely unpredictable, and can be sampled and fed into a computer, avoiding any buffering mechanisms in the operating system. Another source of entropy could be atmospheric noise from a radio, or even just background noise from an office or laboratory.

Electronic data such as a file or packet can be encrypted by means of an algorithm acting on a cryptographic key at one end of a communication path. Where the algorithm is symmetric, the same cryptographic key is used to decrypt the data at the other end of the communication path. Where the algorithm is asymmetric, two keys are required—an encrypting key to encrypt the data and a paired key to decrypt the data. In many common paired key schemes the encrypting key is publicly available while the decrypting key is a private one. An adversary able to intercept a communication and desiring to break an encryption must acquire the decryption key and calculate or guess its value. If an asymmetric algorithm is in play, the decrypting key is not shared or transferred so the adversary will likely not be able to acquire the key. However, the adversary may well have access to the encrypting key and, with time and resources, will be able to calculate the value of the decrypting key. If a symmetric algorithm is in play, the adversary will have a much more difficult time calculating or guessing the value of the key. However, the fact that the key in symmetric algorithms has to be shared renders the key susceptible to interception by an adversary.

Once an adversary has guessed, calculated, or acquired a decryption key, the adversary will have free access to encrypted data until the encryption key is changed. If the encryption key is changed based upon a predictable pattern, the adversary, given time, will be able to predict when the change will occur as well as the value of any new pseudo-random key.

What is needed is a method for allowing programming at each end of a communication path to simultaneously generate identical cryptographic keys in a manner that is not predictable to others. In this way a key does not have to be transferred and is therefore much less likely to be acquired nefariously. In the event a third party is able to calculate a key, the method should allow the same programming to periodically generate, in a manner not predictable to others, new cryptographic keys identical to each other, but different from the previously generated keys. The new keys can then be used to obscure and reveal communications between each end of the communication path. Providing an additional layer or layers of security, the method or methods used to obscure the communication should be randomly chosen using the keys.

### DESCRIPTION OF THE DRAWINGS

FIG. 1 is a schematic diagram of a network in which various embodiments of the present invention may be implemented.

FIG. 2A is a block diagram of the network of FIG. 1 illustrating exemplary components for implementing an embodiment of the present invention.

FIG. 2B is a block diagram illustrating the components of an exemplary sync module according to an embodiment of the present invention.

FIGS. 3 and 4 help to illustrate an exemplary method for generating cryptographic keys according to an embodiment of the present invention.

FIG. 5 is an exemplary flow diagram illustrating steps taken to practice an embodiment of the present invention.

FIGS. 6-8 are block diagram illustrating components of exemplary state modules according to various embodiments of the present invention.

### DETAILED DESCRIPTION

INTRODUCTION: Embodiments of the present invention involve sampling and processing a network data stream at each end of a communication path to generate keys for obscuring and revealing network communications. Because the network data stream is identical at each end of the path, the same key can be generated at different physical locations eliminating the need to share keys. The keys can be used to select the obscuring method or methods. The keys can also be used to determine the period for which they are valid and to generate new keys.

The terms data stream and network communication will be defined and distinguished in the sections to follow. Obscuring means altering network communications from an expected form. This can include encrypting. It can also include altering the manner in which the network communication is transmitted. Multiple methods may be employed to obscure the same network communication. A number of possible methods for obscuring will be described. Revealing, then, means to restore an obscured network communication to its expected form.

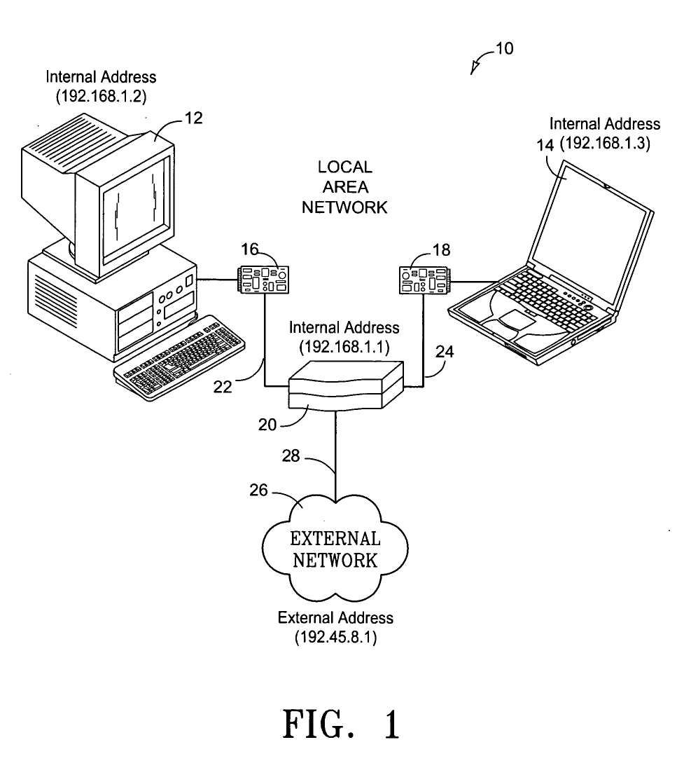

ENVIRONMENT: FIG. 1 is a schematic diagram of a network 10 in which the present invention may be implemented. Network 10 includes computers 12 and 14. Each computer 12 and 14 includes a network interface device 16 or 18. In the example of FIG. 1, network interface device 16 is a network interface card 16, while network interface device 18 is a modem. Environment 10 also includes link 20. Communication paths 22 and 24 connect network interface devices 16 and 18 to link 20. Link 20 is connected to external network 26 by communication path 28. Computers 12 and 14 can each be referred to as a node on network 10. Link 20 can also be referred to as a node on network 10.

Computers 12 and 14 represent generally any devices capable of transmitting and receiving electronic data. While shown as a desktop and laptop computers, devices 12 and 14 could, for example, be personal digital assistants or cellular telephones. Network interface devices 16 and 18 represent generally any combination of hardware and/or programming capable of transmitting and receiving network communications. Link 20 represents generally any combination of hardware and/or programming capable of receiving network communication from computers 12 and 14 and from external network 26 and routing the communication to its intended destination. Where the communication is between computers 12 and 14, link 20 functions as a hub. Where communication is between computer 12 or 14 and external network 26, link 20 functions as a router. The connections between link 20 and paths 22 and 24 are referred to as internal ports, and the connection between link 20 and path 28 to external network 26 is referred to as an external port.

Communication paths 22, 24, and 28 represent generally any medium for transmitting network communications. A path may be wireless or include one or more physical wires, optical cables or any other media through which data may be transmitted One path 22, 24, or 28 may use one medium, while another path may use a different medium. For example, path 24 may use a telephone line, path 22 may use cat-5 cable, and path 28 may use radio frequency.

NETWORK COMMUNICATIONS AND DATA STREAMS: Computers 12 and 14 and link 20 form a local area network. Each has its own internal address while link 20 also has an external address for communicating with external network 26. If, for example, computer 12 wants to send data to computer 14, computer 12 places the data into a packet. For identification and communication purposes computer 12 puts its own address, 192.168.1.2, into the packet. The packet also includes the destination address, 192.168.1.3, for computer 14. In a manner not described here, computer 12 can determine that computer 14 is on the same local area network, so it sends the packet over path 22 to link 20. Link 20 then rebroadcasts the packet through each of its internal ports. Computers 12 and 14 each receive the packet and read the packet's destination address. Recognizing that it is not the intended destination, computer 12 ignores the packet. Computer 14, on the other hand, recognizes that it is the intended recipient of the packet and accepts it. It is noted that multiple packets are usually required to transmit data such as a file between computers 12 and 14.

If, for example, computer 12 wants to send data to external network 26, computer 12 places the data into a packet. The packet includes the source address, 192.168.1.2, and the destination address, 192.45.8.1. In a manner not described here, computer 12 can determine that the destination address is not on the same local area network, so computer 12 includes an intermediate address in the packet—the internal address for link 20—and sends the packet to link 20. Link 20 then rebroadcasts the packet through its external port to external network 26.

Where link 20 receives a packet addressed to computer 12 from external network 26, link 20 rebroadcasts the packet through each of its internal ports, Computers 12 and 14 each receive the packet and read the packet's destination address. Recognizing that it is not the intended destination, computer 14 ignores the packet. Computer 12, on the other hand, recognizes that it is the intended recipient of the packet and reads it.

In operation, link 20 continually and simultaneously broadcasts the same data stream through each of its internal ports. Computers 12 and 14 continually monitor the data stream ignoring some packets and reading others. The data stream broadcast by link 20 and monitored by computers 12 and 14 is generated as a result of various human interactions with computers 12 and 14 and external network 26. Given a sufficiently large number of human interactions contributing to the data stream, that stream is for all intents and purposes truly random and unpredictable. When broadcast by link 20, the data stream is instantaneously received by computers 12 and 14. Link 20 and computers 12 and 14 can simultaneously sample and process the data stream at each end of communication paths 22 and 24 allowing each to generate identical cryptographic keys.

The term network communications refers to all electronic communication between a network of two or more devices. In the example of FIG. 1, network communications includes all the communications broadcast and received at each end of each communication path 22 and 24. By contrast, the term data stream means data broadcast from a source over one communication path or simultaneously over multiple communication paths. In the example of FIG. 1, the term data stream includes the stream of data broadcast by link 20 through each of its internal ports over communication paths 22 and 24. A data stream is then an example of a network communication. Because network communications can come from multiple sources, not all network communications are data streams.

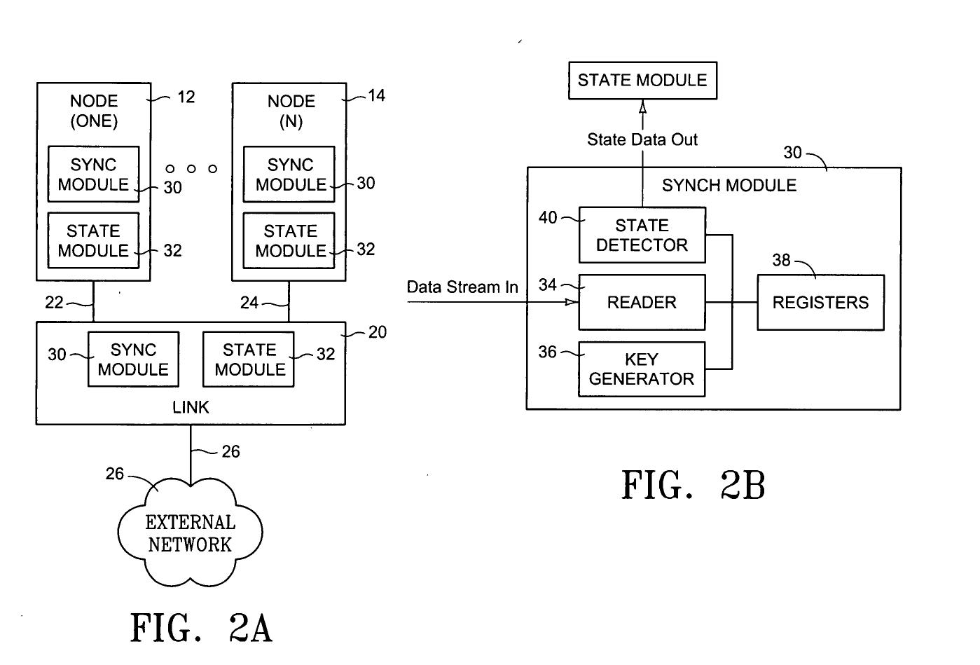

GENERATING KEYSUSING A NETWORK DATA STREAM: An example of the components used and steps taken to generate a key are described in this section. FIG. 2A is a block diagram of the network of FIG. 1. Computers 12 and 14 from FIG. 1 are shown as node (ONE) 12 and node (N) 14 and are joined by link 20. While only nodes 12 and 14 are shown, any number of additional nodes may be present. Link 20 continuously broadcasts the same network data stream to nodes 12 and 14. The network data stream broadcast by link 20 is assembled from communications received from each node 12 and 14 and from external network 26. Each node 12 and 14 has a unique address, and while a given node 12 or 14 listens to or reads the data stream, it ignores portions from the data stream that are not intended for that node.

Embodiments of the present invention can be implemented in sync module 30 and state module 32 present at each node 12 and 14 as well as link 20. Referring back to FIG. 1, sync modules and state modules may be included within the design of link 20 and network interface devices 16 and 18. Sync module 30 represents any combination of hardware and/or programming capable of sampling and processing a network data stream to produce state data. State data is data that identifies the method or methods to be used to obscure and reveal network communications. State module 32 represents any combination of hardware and programming capable of using state data received from sync module 30 to obscure and reveal network communications.

Referring now to FIG. 2B, sync module 30 includes reader 34, key generator 36, registers 38, and state detector 40. Reader 34 represents any combination of programming and/or hardware capable of reading a network data stream. Key generator 36 represents any combination of programming and/or hardware capable of processing data received from the reader in order to generate a cryptographic key. Registers 38 represent memory used to store cryptographic keys. State detector 40 represents generally any combination of programming and/or hardware capable of using a cryptographic key to generate state data.

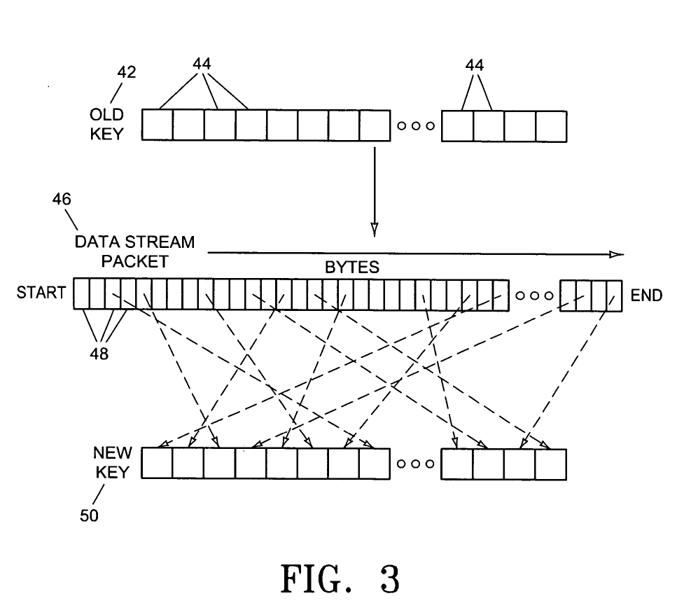

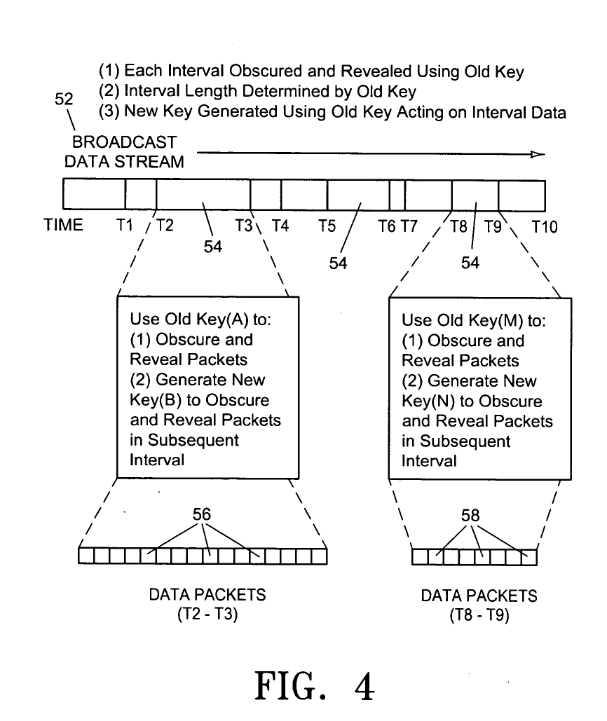

FIGS. 3 and 4 help to illustrate how sync module 30 uses a network data stream to generate cryptographic keys. Starting with FIG. 3 and with reference to FIG. 2B, an existing cryptographic key, referred to as old key 42, is stored in register 38. Old key 42 is made up of a given number of bytes 44. Reader 34 reads a network data stream. In this example, the network data stream is packet 46 which is made up of a number of bytes 48. When processing packet 46, key generator 36 uses old key 42 to generate new key 50. New key 50 is assembled from bytes 48 taken from packet 46. The particular bytes 48 used and the order in which those bytes 48 are assembled to form new key 50 are determined by old key 42. For example, key generator 36 may use an algorithm that operates on the value of old key 42 to specify the particular bytes 48 of packet 46 and the order of those bytes 48 when assembling new key 50.

Referring back to FIG. 2A, sync modules 30 are present at each node 12 and 14 as well as link 20. Because all sync modules 30 are reading the same data stream at the same time, sync modules 30 can simultaneously generate the same new key 50. Once new key 50 is generated, state modules 32 use new key 50 to obscure and reveal network communications. For example, node 12 may broadcast a packet intended for node 14. State module 32 on node 12 uses new key 50 to obscure the packet. Link 20 receives the obscured packet. State module 32 on link 20 reveals the obscured packet using new key 50, obscures the packet again using new key 50, and then broadcasts the obscured packet to both nodes 12 and 14. Each node 12 and 14 receives the packet. State modules 32 at each node 12 and 14 reveal the packet. Node 14 accepts the packet. Node 12 ignores the packet as it is addressed to node 14.

An intruder desiring to calculate a new key must have access to an existing key, the network data stream, and the algorithms used to calculate the new key. To further decrease the likelihood of an intruder's success, new keys are periodically generated.

FIG. 4 helps to illustrate how sync modules 30 periodically generate new keys. A multi-packet data stream is referenced as 52. Data stream 52 is broken into a number of variably sized intervals 54. Each interval 54 includes a number of packets. The length of an interval 54, then, is determined by the number of packets it contains. For example, interval 54 between T2 and T3 includes sixteen packets 56. Interval 54 between T8 and T9 includes eight packets 58. An interval 54 may be of any length. During a specified interval 54, an existing or old key 42 (shown in FIG. 3) is used to obscure and reveal network communications. The length of the interval for which old key 42 is valid can be calculated using old key 42 or any previous key. That is, old key 42 or another previous key can be used to determine the number of packets in an interval 54. During a subsequent interval 54, new key 50 is used to obscure and reveal network communications. Again, the length of the subsequent interval 54 can be calculated by new key 50, old key 42, or a previous key. Key generator 36, for example may be responsible for determining an interval for a given key.

As an example, a new key 50 used to obscure and reveal network communications for the interval 54 between T3 and T4 may be assembled from bytes taken from one or more packets 56 broadcast during the previous interval 54 between T2 and T3. The particular packet 56 used may be determined by old key 42—the key used to obscure and reveal network communications between T2 and T3. Alternately, the particular packet used may be fixed. For example it may always be the first or last packet of an interval 54.

It is extremely unlikely if not impossible for an intruder to successfully calculate a key. Because the keys are not transferred, they cannot be intercepted. Even if a key were calculated or guessed, that key is only valid for a short period of time. Possession of a single key provides insufficient knowledge to reveal data obscured through use of that key; knowledge of each obscuring method employing that key and, possibly, previous keys, must also be obtained before the key may be used to compromise data. Further, possession of a single key does not provide the means for predicting any future or prior key. Therefore, network communications obscured using keys generated in the manner described above are extremely secure when compared to currently exiting levels of security.

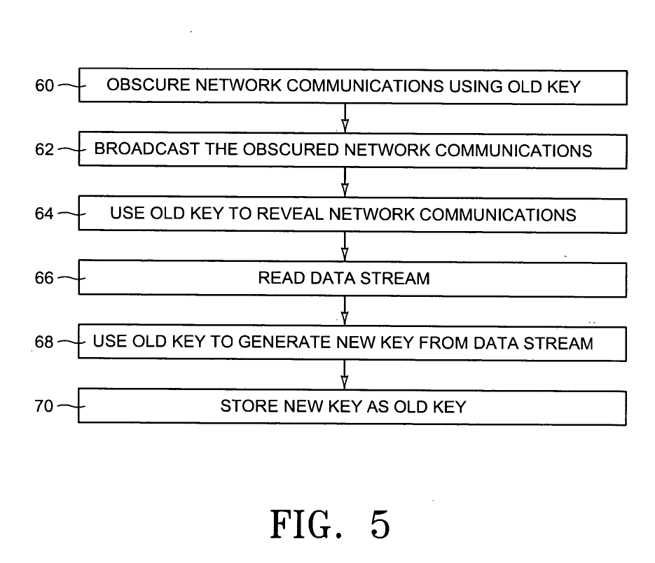

OBSCURING AND REVEALING: FIG. 5 is a flow diagram illustrating steps taken to obscure and reveal network data stream using keys generated by sampling and processing a network data stream. A network communication or portion thereof is obscured using an existing or “old” key (step 60) and then broadcast (step 62). Steps 60 and 62 can occur concurrently at each end of each communication path on a network. In the example of FIG. 1, computers 12 and 14 and link 20 can concurrently obscure and broadcast network communications. The network communications are received and revealed using the old key (step 64). A data stream is read at each end of each communication path (step 66). At each end of each communication path, the data stream and the old key are used to generate new keys (step 68). The new key is then stored as the old key (step 70), and the process repeats with step 60.

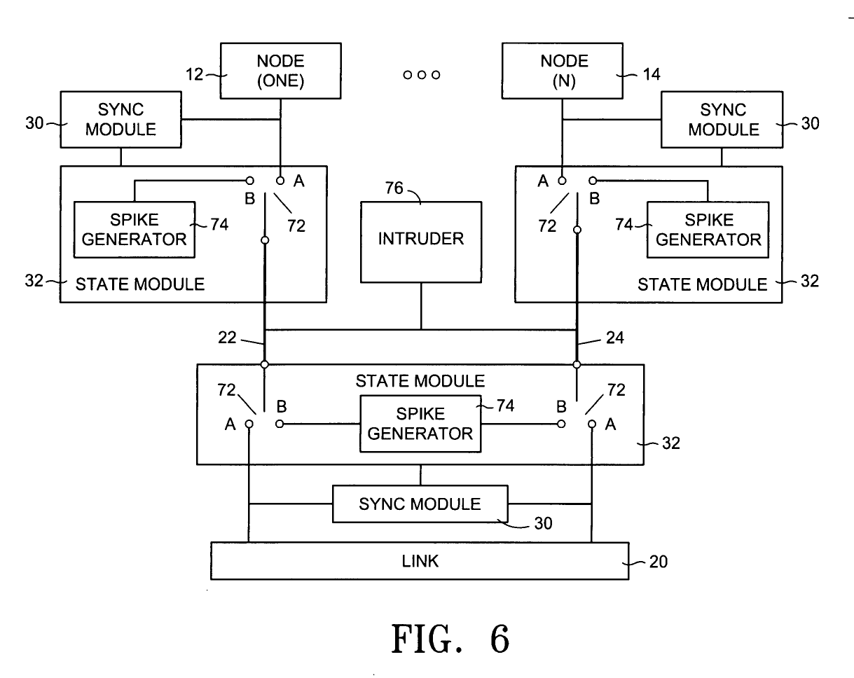

OBSCURING TECHNIQUES: This section describes various components and techniques for obscuring network communications. As described above, state modules 32 present at nodes 12 and 14 as well as link 20 are responsible for using a cryptographic key to obscure and reveal network communications. FIGS. 6-8 illustrate various types of state modules 32.

Referring first to FIG. 6, state modules 32 obscure network communications by randomly isolating nodes 12 and 14 and link 20 and sending voltage spikes or any other disruptive signal over network paths 22 and 24. In this example, state modules 32 include switches 72 and spike generators 74. Switches 72 represent generally any switches capable of isolating components of a network from the communication path or paths joining those components. In FIG. 6, switches 72 isolate nodes 12 and 14 and link 20 from each other and from paths 22 and 24. As illustrated, switches 72 have two positions—A and B. When in position A, switches 72 allow paths 22 and 24 to connect nodes 12 and 14 to link 20. When in position B, switches isolate nodes 12 and 14 and link 20 and connect spike generators 74 to paths 22 and 24. Spike generators 74 represent generally any combination of hardware and programming capable of generating a voltage spike. The voltage spike has a magnitude considerably larger than the voltage or voltages required to transmit network communications over paths 22 and 24. FIG. 6 also shows intruder 76 connected to paths 22 and 24. Intruder 76 represents any electronic device capable of processing network communications. Although FIG. 6 shows spike generators at nodes and links, spike generators may be placed only at nodes or only at links or in any combination of nodes and links as long as there is at least one spike generator along each segment of the network path.

Each state module 32 obtains a key from a connected sync module 30. The keys obtained by each state module 32 are identical. Using the keys, state modules 32 simultaneously place switches 72 in position B, isolating nodes 12 and 14 and link 20 from paths 22 and 24. State modules 32 then cause spike generators 74 to send a voltage spike over paths 22 and 24 damaging or at least temporarily blinding intruder 76. State modules 32 then return switches 72 to position A.

With reference to FIG. 4, state modules 32 may send voltage spikes one or more times during an interval 54. State modules 32 determine the timing using a key generated for that interval 54. For example, voltage spikes may be generated after every tenth packet or only once after the final packet. In some intervals 54, no voltage spikes may be generated.

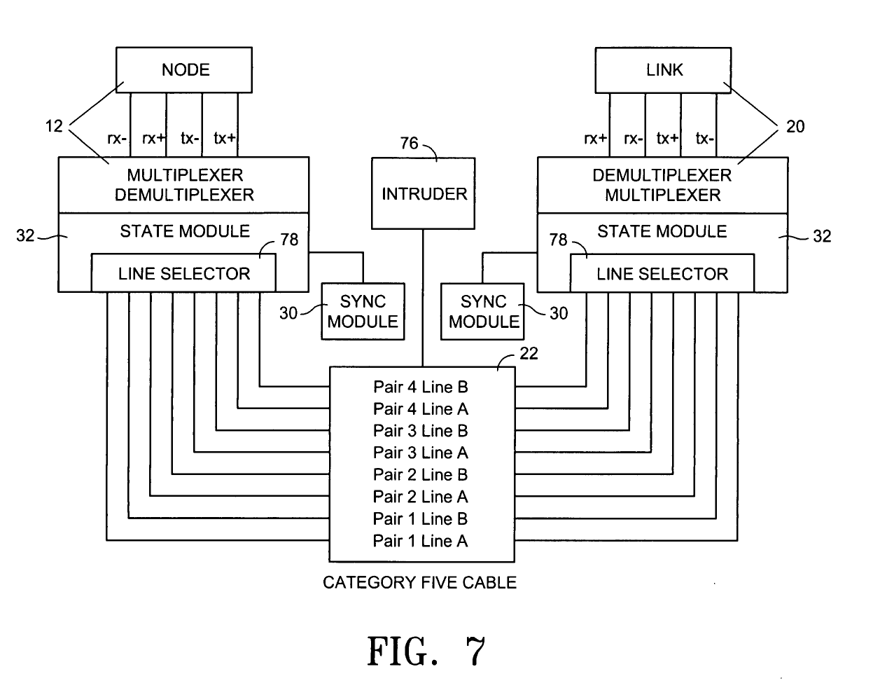

Referring next to FIG. 7, node 12 is connected to link 20 by path 22. While not shown, link 20 is also connected to node 14 and perhaps external network 26 and other nodes not shown. Path 22, in this example is category five cable—also known as Cat-5 cable. Cat-5 cable is made up of four pairs of wires. Node 12 and link 20 only use two pairs or four wires to send and receive network communications. Node 12 and link 20 each include a multiplexer/de-multiplexer responsible for transmitting and receiving network communications over Cat-5 cable. In this example, state modules 32 obscure network communications by periodically swapping the four wires used to send and receive network communications.

State modules 32 each include line selector 78. Line selector 78 represents any combination of hardware and programming capable of selecting the four wires of path 22 to be used to transmit and receive network communications. With reference to FIG. 4, line selections for a given interval 54 may be as follows:

| Line | Node 12 | Link 20 |
|---|---|---|
| Pair 1 - Line B | Tx+ | Rx+ |
| Pair 2 - Line A | Tx− | Rx− |
| Pair 3 - Line A | Rx+ | Tx+ |
| Pair 3 - Line B | Rx− | Tx− |

For a subsequent interval, the line selections may be switched as follows:

| Line | Node 12 | Link 20 |
|---|---|---|
| Pair 4 - Line B | Tx+ | Rx+ |
| Pair 1 - Line A | Tx− | Rx− |
| Pair 2 - Line B | Rx+ | Tx+ |
| Pair 3 - Line A | Rx− | Tx− |

State modules 32 use keys obtained from sync modules 30 to determine the line selections. As the keys are changed, so are the line selections. As long as identical keys are used by state modules 32, line selectors 78 will correctly select the same lines for complimentary purposes. For example, where a line is selected to transmit network communications from node 12, the same line is used by link 20 to receive the communication.

FIG. 7 also shows intruder 76 connected to path 22. Base upon industry standards, the same line selections for Cat-5 cable are always used. By obscuring which line is being used for which purpose, intruder 76 will not be able to easily decipher the intercepted network communications. Intruder 76 must monitor all 8 wires of the Cat-5 cable and is unable to detect both the direction of the signals (receiving or transmitting) and the polarity of the signal (+ or −). As the line selections continually change, the job of intruder 76 becomes even more difficult if not impossible.

It is noted that this same technique for obscuring network communications is not limited to situations where Cat 5 cable is being used. For example, with wireless communication, one frequency may be used to transmit and another frequency to receive. The same technique described with reference to FIG. 7 can be used to periodically swap the frequencies used to send and receive. In other words, the technique described can be used to periodically swap the communication lines used to send and receive network communications regardless of the nature of those lines.

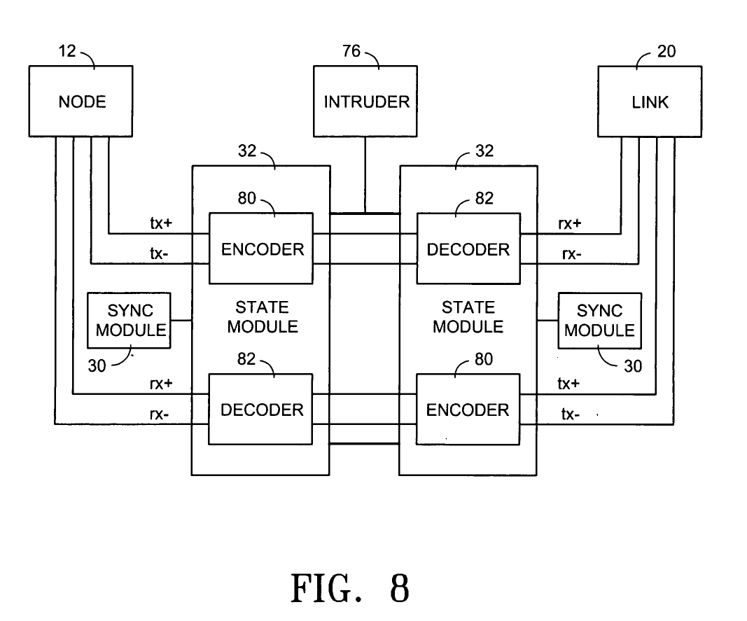

Referring now to FIG. 8, node 12 is connected to link 20 by path 22. While not shown, link 20 is also connected to node 14 and perhaps external network 26 or other nodes not shown. In this example, state modules 32 obscure network communications by encoding. Encoding means to alter, in some fashion, the bits, bytes, packets used to transmit the network communication. Examples include encrypting packets, adding meaningless data such as cryptographic nulls, and adjusting the voltage levels used to transmit packets over path 22.

To achieve these purposes, state modules 32 include encoders 80 and decoders 82. Encoders 80 represent any combination of hardware and/or programming capable of using a key to encode network communications. Decoders 82 represent any combination of hardware and/or programming capable of using a key to decode network communications. With reference to FIG. 4, during a given interval 54 encoders 80 and decoders 82 use identical keys obtained from sync modules 30 to determine a method or methods for encoding and decoding. The keys are also used to determine the order in which methods for encoding and decoding are employed. For example, during a given interval 54 a packet may be encoded in the following sequence: method A, method D, method C. The packet is then decoded in reverse sequence: method C, method D, method A. During a subsequent interval, a new key is used to select the methods and method order for encoding and decoding network communications.

FIG. 8 also shows intruder 76 connected to path 22. Without knowing the methods and sequence used to encode the network communications, intruder 76 will have an extremely difficult time deciphering any intercepted data. As the methods and method order for encoding continually change, the job of intruder 76 becomes even more difficult if not impossible.

As noted above, a method for encoding packets includes encryption. Another method includes adding meaningless data such as cryptographic nulls. A packet is made up of a series of bits—ones and zeros. A packet can be encoded by inserting meaningless bits into the packet at varying points. Encoders 80 do this in a manner determined using a key obtained from sync module 30. Decoders 82 use the same key to determine which of the bits in a packet are meaningless and then remove those bits.

Another method for encoding a packet involves adjusting the voltage levels used to transmit the packets. Typically two voltage levels are used. A zero is represented by one level and a one is represented by the other level.

| Voltage Level | Bits |
|---|---|
| A | 0 |
| B | 1 |

In a protocol commonly referred to as 2B1Q (2 Binary 1 Quaternary), four voltage levels are used. Each level represents two bits.

| Voltage Level | Bits |
|---|---|
| A | 00 |
| B | 01 |
| C | 10 |
| D | 11 |

Similarly, eight voltage levels could be used with each level representing three bits.

| Voltage Level | Bits |
|---|---|
| A | 000 |
| B | 001 |
| C | 010 |
| D | 011 |
| E | 100 |
| F | 101 |
| G | 110 |
| H | 111 |

A data stream may be encoded by periodically switching the number of voltage levels used to represents bits in that data stream.

In addition to switching the number of voltage levels used, encoding can be accomplished by periodically switching the bias point. For example, where two voltage levels A and B are used, level A may be at ten volts relative to a ground and level B may be at fifteen volts. Relative to each other level A is at zero volts and level B is at five volts. The bias point is ten volts. Switching the bias point to twenty five volts sets level A at twenty-five volts relative to the ground and level B at thirty volts relative to the ground. Changing the bias makes it difficult for intruder 76 to set up the equipment necessary to read the data stream. Each change of bias requires new calibration of monitoring equipment.

The voltage level used to represent a given bit or bits can also be changed periodically. Using the 2B1Q protocol described above, voltage levels during a given interval 54 (FIG. 4) may be set as follows.

| Voltage Level | Bits |
|---|---|
| A | 00 |
| B | 01 |
| C | 10 |
| D | 11 |

During a subsequent interval, the levels may be altered as follows.

| Voltage Level | Bits |
|---|---|
| D | 00 |
| A | 01 |
| C | 10 |
| B | 11 |

CONCLUSION: By sampling and processing a network data stream, identical keys can be generated simultaneously at different physical locations. Because the data stream is a product of a large number of human-computer interactions, the data stream is truly random. Consequently, the keys generated are also random. Because the keys do not need to be transferred, the risk that they will be intercepted is reduced if not eliminated. In the unlikely event that an intruder is able to calculate or guess a key, new, unrelated keys are periodically generated. The value of the new key is determined by sampling and processing the network data stream in a manner dictated by the existing key or some previous key. The interval for which a key is valid may be dictated by that key or a previous key.

State monitors 32, using an existing key, determine and employ the method or methods used to obscure and then reveal network communications during a given interval. FIGS. 6-8 each show state monitors 32 having different components. In FIG. 6, state monitors 32 include switches 72 and spike generators 74. In FIG. 7, state modules 32 include line selectors 78. In FIG. 8, state modules 32 include encoders 80 and decoders 82. It is noted that each state module 32 may include all of these components and/or other components for obscuring and revealing that are not shown.

While the above description involves obscuring and revealing network communications between computers. The same techniques can be used to obscure any digital communication. For example, the techniques described may for example be employed to obscure digital voice communications or digital audio/video signals. All that is required is a data stream that can be sampled and processed at each end of a communication path, sync modules at each end that use the data stream to calculate keys, and state modules at each end that use the keys to obscure and reveal network communications.

FIG. 1 illustrates an exemplary environment in which various embodiments of the present invention may be implemented. The environment shown however is merely an example. Embodiments of the present invention can be implemented in any environment in which electronic devices exchange information. The block diagrams of FIGS. 2A, 2B, 6, 7, and 8 show the architecture, functionality, and operation of an exemplary embodiments of the present invention. Each block may represent in whole or in part a module, segment, or portion of code that comprises one or more executable instructions to implement the specified logical function(s). Each block may represent a circuit or a number of interconnected circuits to implement the specified logical f unction(s).

Also, the present invention can be embodied in any computer-readable medium for use by or in connection with an instruction execution system such as a computer/processor based system or an ASIC (Application Specific Integrated Circuit) or other system that can fetch or obtain the logic from computer-readable media and execute the instructions contained therein. “Computer-readable medium” can be any of one or more computer readable media that can contain, store, or maintain programs and data for use by or in connection with the instruction execution system. Computer readable media can comprise any one of many physical media such as, for example, electronic, magnetic, optical, electromagnetic, infrared, or semiconductor media. More specific examples of suitable computer-readable media include, but are not limited to, a portable magnetic computer diskette such as floppy diskettes or hard drives, a random access memory (RAM), a read-only memory (ROM), an erasable programmable read-only memory, or a portable compact disc.

Although the flow charts of FIG. 5 shows a specific order of execution, the order of execution may differ from those depicted. For example, the order of execution of two or more blocks may be scrambled relative to the order shown. Also, two or more blocks shown in succession may be executed concurrently or with partial concurrence. All such variations are within the scope of the present invention.

Embodiments of the present invention have been shown and described with reference to the foregoing exemplary implementations. It is to be understood, however, that other forms, details, and embodiments may be made without departing from the spirit and scope of the invention which is defined in the following claims.

1. A method for generating a key, comprising:
reading a network data stream;
selecting a portion of data from the data stream; and
forming the key from the selected portion.

2. The method of claim 1, wherein the key is a new key, and wherein selecting comprises using an old key to select portions of the data stream, and wherein forming comprises using the old key to specify an order and assembling the selected portions in the specified order to form the new key.

3. The method of claim 2, further comprising identifying the new key as the old key and repeating the steps of reading, selecting, and forming to generate another new key.

4. The method of claim 2, wherein:
reading comprises reading the network data stream at a first node and reading the network stream at a second node;
selecting comprises using the old key to select first portions of the data stream read from the first node and using the old key to select second portions of the data stream read from the second node; and
wherein assembling comprises using the old key to specify a first order in which the selected first portions are to be assembled to form a first new key and using the old key to specify a second order in which the selected second portions are to be assembled to form a second new key.

5. The method of claim 1, further comprising determining an interval for which the key is valid and repeating the steps of reading, selecting, and forming to create another key for a subsequent interval.

6. The method of claim 5, wherein determining comprises using the key to determine the interval for which the key is valid.

7. The method of claim 5, wherein determining comprises using an old key to determine the interval for which the key is valid.

8. A method for secure network communication, comprising:
reading a network data stream;
generating a key from the data stream; and
altering at least a portion of a network communication using the key.

9. The method of claim 8, wherein generating comprises:
selecting portions of data from the data stream; and
assembling the selected portions to form the key.

10. The method of claim 9, wherein the key is a new key, and wherein selecting comprises using an old key to select the portions of the data stream, and wherein assembling comprises using the old key to specify an order in which the selected portions are to be assembled to form the new key.

11. The method of claim 8, wherein:
generating comprises using an old key to generating a new key from the data stream; and
altering comprises altering at least a portion of the network communication using the new key.

12. The method of claim 8, the wherein altering comprises revealing at least a portion of the network communication using the key.

13. The method of claim 8, wherein altering comprises obscuring at least a portion of the network communication using the key.

14. The method of claim 13, wherein:
reading comprises reading the data stream at a first node and at a second node;
generating comprises generating a first key using the data stream read at the first node and generating a second key using the data stream read at the second node;
obscuring comprises obscuring at least a portion of the electronic communication using the first key; and
the method further comprising revealing at least a portion of the electronic communication using the second key.

15. The method of claim 14, wherein the first and second keys are identical.

16. The method of claim 8, wherein altering comprises isolating a network node from a network path and sending a disruptive signal over the network path.

17. The method of claim 16, wherein sending a disruptive signal includes sending a voltage spike over the network path.

18. The method of claim 16, wherein altering further comprises determining a timing using the key, and wherein isolating and sending comprise isolating the node and sending the disruptive signal according to the timing.

19. The method of claim 16, wherein:
altering further comprises determining a timing using the key; isolating comprises:
isolating a first network node from a first network path according to the timing;
isolating a second network node from a second network path according to the timing; and
sending comprises sending the disruptive signal over the first and second network paths according to the timing.

20. The method of claim 8, wherein altering comprises periodically swapping communication lines used to send and receive network communications.

21. The method of claim 20, wherein altering further comprises determining a timing according to the key, and wherein swapping comprises periodically swapping the communication lines used to send and receive network communications according to the timing.

22. The method of claim 20, wherein:
altering further comprises determining a timing according to the key; and swapping comprises:
periodically swapping communication lines used by a first node to send and receive network communications according to the timing; and
periodically swapping communication lines used by a second node to send and receive network communications according to the timing.

23. The method of claim 8, wherein altering comprises decoding at least a portion of the network communication using the key.

24. The method of claim 8, wherein altering comprises encoding at least a portion of the network communication using the key.

25. The method of claim 24, further comprising using the key to determine an encoding method, and wherein encoding comprises encoding at least a portion of the network communication according to the encoding method.

26. The method of claim 24, further comprising using the key to determine a sequence of encoding methods, and wherein encoding comprises encoding at least a portion of the network communication according to the sequence of encoding methods.

27. The method of claim 24, wherein:
reading comprises reading the data stream at a first node and at a second node;
generating comprises generating a first key using the data stream read at the first node and generating a second key using the data stream read at the second node;
encoding comprises encoding at least a portion of the electronic communication using the first key; and
the method further comprising decoding at least a portion of the electronic communication using the second key.

28. The method of claim 27:
further comprising using the first key to determine an encoding method, and wherein encoding comprises encoding at least a portion of the network communication according to the encoding method using the first key; and
further comprising using the second key to determine a decoding method, and wherein decoding comprises decoding at least a portion of the network communication according to the decoding method using the second key.

29. The method of claim 27:
further comprising using the first key to determine a sequence of encoding methods, and wherein encoding comprises encoding at least a portion of the network communication according to the sequence of encoding methods using the first key; and
further comprising using the second key to determined sequence of decoding methods, and wherein decoding comprises decoding at least a portion of the network communication according to the sequence decoding methods using the second key.

30. A method for secure network communication, comprising:
generating a first key from first selected portions of a network data stream;
determining a first interval;
altering at least a portion of a network communication using the first key during the first interval;
generating a second key from second selected portions of the network data stream;
determining a second interval; and
altering at least a portion of a network communication using the second key during the second interval.

31. The method of claim 30, wherein generating the second key comprises using the first key to select the second selected portions of the network data stream.

32. The method of claim 31, wherein generating the second key comprises using the first key to specify and order for assembling the selected second portions of the network data stream to form the second key.

33. The method of claim 30, wherein determining the second interval comprises using the first key to determine the second interval.

34. The method of claim 30, wherein determining the second interval comprises using the second key to determine the second interval.

35. A computer readable medium having instructions for:
reading a network data stream;
selecting a portion of data from the data stream; and
forming a key from the selected portion.

36. The medium of claim 35, wherein the key is a new key, and wherein the instructions for selecting include instructions for using an old key to select portions of the data stream, and wherein the instructions for forming include instructions for using the old key to specify an order and for assembling the selected portions in the specified order to form the new key.

37. The medium of claim 36, having further instructions for identifying the new key as the old key and repeating the instructions for reading, selecting, and forming to generate another new key.

38. The medium of claim 36, wherein the instructions for:
reading include instructions for reading the network data stream at a first node and reading the network stream at a second node;
selecting include instructions for using the old key to select first portions of the data stream read from the first node and using the old key to select second portions of the data stream read from the second node; and
assembling include instructions for using the old key to specify a first order in which the selected first portions are to be assembled to form a first new key and using the old key to specify a second order in which the selected second portions are to be assembled to form a second new key.

39. The medium of claim 35, having further instructions for determining an interval for which the key is valid and repeating the instructions for reading, selecting, and forming to create another key for a subsequent interval.

40. The medium of claim 39, wherein the instructions for determining comprises using the key to determine the interval for which the key is valid.

41. The medium of claim 39, wherein the instructions for determining comprises using an old key to determine the interval for which the key is valid.

42. A computer readable medium having instructions for:
reading a network data stream;
generating a key from the data stream; and
altering at least a portion of a network communication using the key.

43. The medium of claim 42, wherein the instructions for generating include instructions for:
selecting portions of data from the data stream; and
assembling the selected portions to form the key.

44. The medium of claim 43, wherein the key is a new key, and wherein the instructions for selecting include instructions for using an old key to select the portions of the data stream, and wherein the instructions for assembling include instructions for using the old key to specify an order in which the selected portions are to be assembled to form the new key.

45. The medium of claim 42, wherein the instructions for:
generating include instructions for using an old key to generating a new key from the data stream; and
altering include instructions for altering at least a portion of the network communication using the new key.

46. The medium of claim 42, the wherein the instructions for altering include instructions for revealing at least a portion of the network communication using the key.

47. The medium of claim 42, wherein the instructions for altering include instructions for obscuring at least a portion of the network communication using the key.

48. The medium of claim 47, wherein the instructions for:
reading include instructions for reading the data stream at a first node and at a second node;
generating include instructions for generating a first key using the data stream read at the first node and generating a second key using the data stream read at the second node;
obscuring include instructions for obscuring at least a portion of the electronic communication using the first key; and
the medium having further instructions revealing at least a portion of the electronic communication using the second key.

49. The medium of claim 48, wherein the first and second keys are identical.

50. The medium of claim 42, wherein the instructions for altering include instructions for isolating a network node from a network path and sending a disruptive signal over the network path.

51. The medium of claim 50, wherein the instructions for sending a disruptive signal includes sending a voltage spike over the network path.

52. The medium of claim 50, wherein the instructions for altering further include instructions for determining a timing using the key, and wherein the instructions for isolating and sending comprise isolating the node and sending the disruptive signal according to the timing.

53. The medium of claim 50, wherein the instructions for:
altering further include instructions for determining a timing using the key; isolating include instructions for:
isolating a first network node from a first network path according to the timing;
isolating a second network node from a second network path according to the timing; and
sending include instructions for sending the disruptive signal over the first and second network paths according to the timing.

54. The medium of claim 42, wherein the instructions for altering include instructions for periodically swapping communication lines used to send and receive network communications.

55. The medium of claim 54, wherein the instructions for altering further include instructions for determining a timing according to the key, and wherein the instructions for swapping include instructions for periodically swapping the communication lines used to send and receive network communications according to the timing.

56. The medium of claim 54, wherein the instructions for:
altering further include instructions for determining a timing according to the key; and
swapping include instructions for:
periodically swapping communication lines used by a first node to send and receive network communications according to the timing; and
periodically swapping communication lines used by a second node to send and receive network communications according to the timing.

57. The medium of claim 42, wherein the instructions for altering include instructions for decoding at least a portion of the network communication using the key.

58. The medium of claim 42, wherein the instructions for altering include instructions for encoding at least a portion of the network communication using the key.

59. The medium of claim 58, having further instructions for using the key to determine an encoding method, and wherein the instructions for encoding include instructions for encoding at least a portion of the network communication according to the encoding method.

60. The medium of claim 58, having further instructions for using the key to determine a sequence of encoding methods, and wherein the instructions for encoding include instructions for encoding at least a portion of the network communication according to the sequence of encoding methods.

61. The medium of claim 58, wherein the instructions for:
reading include instructions for reading the data stream at a first node and at a second node;
generating include instructions for generating a first key using the data stream read at the first node and generating a second key using the data stream read at the second node;
encoding include instructions for encoding at least a portion of the electronic communication using the first key; and
the medium having further instructions for decoding at least a portion of the electronic communication using the second key.

62. The medium of claim 61:
having further instructions for using the first key to determine an encoding method, and wherein the instructions for encoding include instructions for encoding at least a portion of the network communication according to the encoding method using the first key; and
having further instructions for using the second key to determine a decoding method, and wherein the instructions for decoding include instructions for decoding at least a portion of the network communication according to the decoding method using the second key.

63. The medium of claim 61:
having further instructions for using the first key to determine a sequence of encoding methods, and wherein the instructions for encoding include instructions for encoding at least a portion of the network communication according to the sequence of encoding methods using the first key; and
having further instructions for using the second key to determine a sequence of decoding methods, and wherein the instructions for decoding include instructions for decoding at least a portion of the network communication according to the sequence decoding methods using the second key.

64. A computer readable medium having instructions for:
generating a first key from first selected portions of a network data stream;
determining a first interval;
altering at least a portion of a network communication using the first key during the first interval;
generating a second key from second selected portions of the network data stream;
determining a second interval; and
altering at least a portion of a network communication using the second key during the second interval.

65. The medium of claim 64, wherein the instructions for generating the second key include instructions for using the first key to select the second selected portions of the network data stream.

66. The medium of claim 65, wherein the instructions for generating the second key include instructions for using the first key to specify and order for assembling the selected second portions of the network data stream to form the second key.

67. The medium of claim 64, wherein the instructions for determining the second interval include instructions for using the first key to determine the second interval.

68. The medium of claim 64, wherein the instructions for determining the second interval include instructions for using the second key to determine the second interval.

69. A system for generating a key, comprising:
a reader operable to read a network data stream; and
a key generator operable to select portions of data from the data stream and to assemble the selected portions to form the key.

70. The system of claim 69, wherein the key is a new key, and wherein the reader is operable to use an old key to select the portions of the data stream and to use the old key to specify an order in which the selected portions are to be assembled to form the new key.

71. The system of claim 70,
wherein the reader is a first reader operable to read the network data stream at a first node, and the key generator is a first key generator operable to use the old key to select first portions of the data stream read from the first node and to specify a first order in which the selected first portions are to be assembled to form a first new key;
the system further comprising:
second reader operable to read the network data at a second node; and
a second key generator operable to use the old key to select second portions of the data stream read from the second node and to us the old key to specify a second order in which the selected second portions are to be assembled to form a second new key.

72. The system of claim 71, wherein the first portions are identical to the second portions and the first order is identical to the second order.

73. A system for secure network communication, comprising:
a reader operable to read a network data stream; and
a key generator operable to generate a key from the network data stream; and
a state module operable to alter at least a portion of a network communication using the key.

74. The system of claim 73, wherein the key generator is operable to select portions of data from the data stream, and to assemble the selected portions to form the key.

75. The system of claim 74, wherein the key is a new key, and wherein the key generator is operable to use an old key to select the portions of the data stream and to use the old key to specify an order in which the selected portions are to be assembled to form the new key.

76. The system of claim 73, wherein the network communication has been obscured, and wherein the state module is operable to alter by revealing at least a portion of the obscured network communication using the key.

77. The system of claim 73, wherein the state module is operable to alter by obscuring at least a portion of the network communication using the key.

78. The system of claim 73, wherein the state module includes:
a switch operable to isolate a node from a network path; and
a spike generator operable to send a disruptive signal over the network path.

79. The system of claim 78, wherein the spike generator is operable to send a voltage spike over the network path.

80. The system of claim 78, wherein the state module is operable to determine a timing using the key, and wherein the switch and the spike generator are operable to isolating the node and send the disruptive signal according to the timing.

81. The system of claim 73, wherein the state module is operable to alter by periodically swapping communication lines used to send and receive network communications.

82. The system of claim 81, wherein the state module is operable to determine a timing according to the key and to periodically swap the communication lines used to send and receive network communications according to the timing.

83. The system of claim 73, wherein the network communication has been encoded, and wherein the state module is operable to alter by decoding at least a portion of the network communication using the key.

84. The system of claim 73, wherein the state module is operable to alter by encoding at least a portion of the network communication using the key.

85. The system of claim 84, wherein the state module is operable to use the key to determine an encoding method and to alter by encoding at least a portion of the network communication according to the encoding method.

86. The system of claim 84, wherein the state module is operable to use the key to determine a sequence of encoding methods and to alter by encoding at least a portion of the network communication according to the sequence of encoding methods.

87. The system of claim 84, wherein the network communication has been encoded, and wherein the state module is operable to use the key to determine a decoding method and to alter by decoding at least a portion of the network communication according to the decoding method.

88. The system of claim 84 wherein the network communication has been encoded, and wherein the state module is operable to use the key to determine a sequence of decoding methods and to alter by decoding at least a portion of the network communication according to the sequence of decoding methods.

89. A system for secure network communication, comprising:
a key generator operable to generate a first key from first selected portions of a network data stream and to determine a first interval;
a state module operable to alter at least a portion of a network communication using the first key during the first interval;
wherein the key generator is further operable to generate a second key from second selected portions of the network data stream and to determine a second interval; and
wherein the state module is further operable to alter at least a portion of a network communication using the second key during the second interval.

90. The system of claim 89, wherein the key generator is operable to use the first key to select the second selected portions of the network data stream.

91. The system of claim 90, wherein the key generator is operable to use the first key to specify an order for assembling the selected second portions of the network data stream to form the second key.

92. The system of claim 89, wherein the key generator is operable to use the first key to determine the second interval.

93. The system of claim 89, wherein the key generator is operable to use the second key to determine the second interval.

94. An computer network, comprising:
a first node and a second node;
a first sync module operable to read a network data stream at the first node and to generate a first key from the network data stream read from the first node;
a first state module operable to obscure at a network communication using the first key;
a second sync module operable to read the network data stream at the second node and to generate a second key from the network data stream read at the second node; and
a second state module operable to reveal the network communication using the second key.

95. The network of claim 94, wherein the first and second keys are identical.

96. The network of claim 94, further comprising a link joining the first node to the second node, the link comprising:
a third sync module operable to read the network data stream and to generate a third key from the network data stream; and
a third state module operable to reveal the network communication using the third key.

97. The network of claim 96, wherein the first, second key, and third keys are identical.

98. A system for generating a key, comprising:
a means for reading a network data stream;
a means for selecting portions of data from the data stream; and
a means for assembling the selected portions to form the key.

99. A system for secure network communication, comprising:
a means for reading a network data stream;
a means for generating a key from the network data stream; and
a means for altering at least a portion of a network communication using the key

100. A system for secure network communication, comprising:
a means for generating a first key from first selected portions of a network data stream;
a means for determining a first interval;
a means for altering at least a portion of a network communication using the first key during the first interval;
a means for generating a second key from second selected portions of the network data stream;
a means for determining a second interval; and
a means for altering at least a portion of a network communication using the second key during the second interval.
